(19) United States
(12) Patent Application Publication
(10) Pub. No.: US 2007/0182270 A1
(43) Pub. Date: Aug. 9, 2007

(54) Motor stator device

(75) Inventor: Fei-Tyh Chuang, Tainan County (TW)

Correspondence Address: BIRCH STEWART KOLASCH & BIRCH, PO BOX 747, FALLS CHURCH, VA, 22040-0747, US

(73) Assignees: Jaquar Precision Industry Co., Ltd., Taipei Hsien (TW); Fei-Tyh CHUANG, Tainan County (TW)

(21) Appl. No.: 11/349,198

(22) Filed: Feb. 8, 2006

(51) Int. Cl. H02K 1/10; H02K 1/28; H02K 1/12

(52) U.S. Cl. 310/218; 310/186; 310/259

(57) ABSTRACT

This invention relates to a motor stator device comprising a stator, a plurality of coils, and a rotor. The stator includes a plurality of serrate portions, and a positioning slot disposed between two serrate portions at an internal wall of the stator, and each positioning slot having a tooth; each coil being wound around each serrate portion in the stator and disposed inside the rotor for producing an electromagnetic attraction when the coil on the stator is connected electrically, so as to drive the rotor to rotate, and enhance the area occupying percentage and the performance of the conducting wire and lower the detention torque without affecting the rigidity of the motor.

### BACKGROUND OF THE INVENTION

1. Field of the Invention

The present invention relates to a motor stator device, and more particularly to a motor stator device having a positioning slot disposed between two adjacent serrate portions at an internal wall of the stator to match with the design of a tooth to improve the area occupying percentage and the using percentage as well as lower the detention torque effect. The invention not only reduces the overall rigidity of the motor, but also fits different motors or other similar devices.

2. Description of the Related Art

A traditional motor device generally includes a stator 1, a plurality of coils 2, and a rotor 3 as shown in FIG. 1. The stator 1 includes a plurality of serrate portions 4, and each coil 2 is wound around each serrate portion 4 in the stator 1, and the rotor 3 is installed in the stator 1 for producing an electromagnetic attraction to drive the rotor 3 to rotate, when the coil 2 on the stator 1 is connected electrically. Although the prior art has the rotation effect, the gap of a tooth groove between the serrate portions in the stator 1 is too small, and thus it is quite inconvenient to wind the coil 2, and the thickness and winding volume of the coil 2 are restricted. Particularly, if a thick wire is wound, the winding pipe will be thick, too. As a result, the space between the coils 2 wound around two adjacent serrate portions 4 will become larger, and the area occupying percentage of the conducting wire will be smaller, and the overall performance will be lowered. Furthermore, a large gap between tooth grooves cannot lower the detention torque, and thus making both design and manufacturing difficult. A certain kind of motors adds a small tooth without winding the gap between two adjacent teeth to reduce the detention torque effect, so as to decrease the gap between tooth grooves, and thus enhancing the motor performance and reducing the tooth groove effect. Another kind of motors has the characteristic of |2P-NS|=2 (where P is the number of pole pairs and NS is the number of teeth), and such motor includes a stator, a plurality of coils, and a rotor (not shown in the figure). The stator includes a large serrate portion (NS/2) and a small serrate portion (NS/2), and the coil is wound around each large serrate portion only, and the rotor is installed in the stator for producing an electromagnetic attraction to drive the rotor to rotate, when the coil on the stator is connected electrically. Since the curvature of the teeth of the serrate portion in the motors of this kind can be adjusted close to a magnetic arc, therefore a larger flux linkage can be produced to improve the overall efficiency The foregoing two kinds of motors are rather difficult to be manufactured by automation. In general, the coil is wound on the stator first, and then wound into the tooth grooves, so that the coil will not be tight, and the winding will create a larger resistance at the ends. If the winding wire is too thick, a larger opening of the groove is needed, and thus the application cannot meet user requirements.

### SUMMARY OF THE INVENTION

The primary objective of the present invention is to provide a motor stator device comprising a stator, a plurality of coils, and a rotor, wherein the stator includes a positioning slot disposed between two serrate portions having windings adjacent to an internal wall of the stator, and a corresponding tooth without any winding, such that each coil can be wound around each serrate portion in the stator first. By then, each tooth without winding is not connected with the stator yet, and a combining portion at an end of the tooth that awaits to be wound by a coil will be connected to the positioning slot at an internal wall of the stator, such that this space can be used for winding, and the winding will not be restricted by the gaps between the tooth grooves, and the space for winding each coil becomes relatively larger to facilitate the winding of a thicker coil. Compared with a general motor, the volume of the coil can be increased accordingly to effectively improve the area occupying percentage of the conducting wire and reduce the detention torque, so as to enhance the practicability and convenience of the motor.

The secondary objective of the present invention is to provide a motor stator device that includes an integrally formed stator to give a good overall rigidity of the motor and improve the practicability of the motor stator device.

Another objective of the present invention is to provide a motor stator device that includes a positioning slot between two adjacent serrate portions of the stator and a tooth for effectively reducing the gap of the tooth groove between an extending portion of the serrate portion and an extending portion of the tooth, so as to effectively lower the tooth groove effect and enhance the overall performance and practicability.

Another objective of the present invention is to provide a motor stator device that includes a positioning slot disposed between two adjacent serrate portions of the stator and a tooth each, so as to comply with the maximum utility of |2P-NS|=2 (where P is the number of pole pairs and NS is the number of teeth) and concurrently have the effects of winding conveniently and enhancing the practicability.

To achieve the foregoing objectives, the motor stator device of the invention comprises a stator, a plurality of coils, and a rotor. A stator has a plurality of serrate portions therein, and a positioning slot is disposed between two adjacent serrate portions of an internal wall of the stator, and each positioning slot comes with a tooth. A plurality of coils are provided and each coil is wound around each serrate portion in the stator. A rotor is installed in the stator for producing an electromagnetic attraction to drive the rotor to rotate, when the coil on the stator is connected electrically. Therefore, the overall rigidity of the motor, the area occupying percentage of the conducting wire, and the performance can be enhanced while the detention torque can be reduced without affecting the overall rigidity of the motor.

### BRIEF DESCRIPTION OF THE DRAWINGS

FIG. 1 is a schematic perspective view of a prior art;

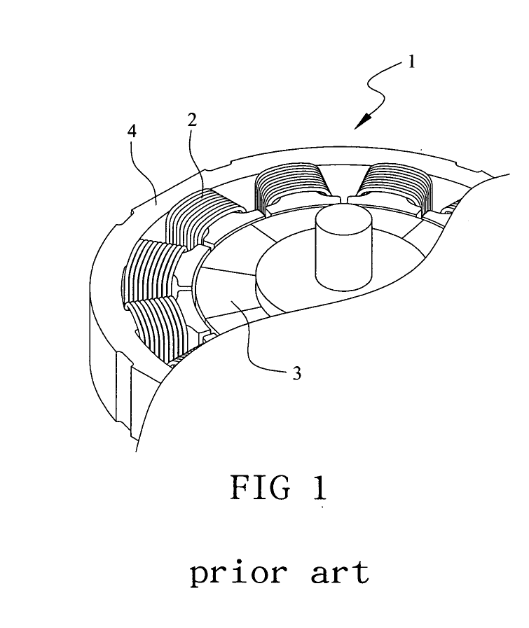

FIG. 2 is a perspective view of the present invention;

FIG. 3 is an exploded view of the present invention;

FIG. 4 is a schematic planar view of the present invention;

FIG. 5 is a schematic view of teeth according to a second preferred embodiment of the present invention;

FIG. 6 is a schematic view of teeth according to a third preferred embodiment of the present invention;

FIG. 7 is a schematic view of teeth according to a fourth preferred embodiment of the present invention; and

FIG. 8 is a schematic view of teeth according to a fifth preferred embodiment of the present invention.

### DETAILED DESCRIPTION OF THE PREFERRED EMBODIMENTS

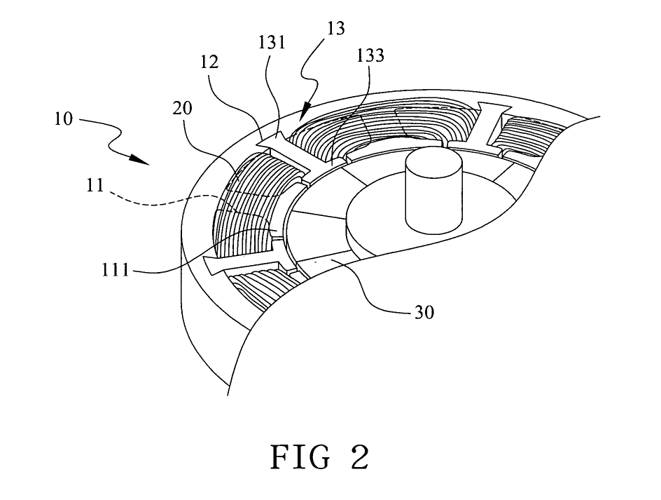

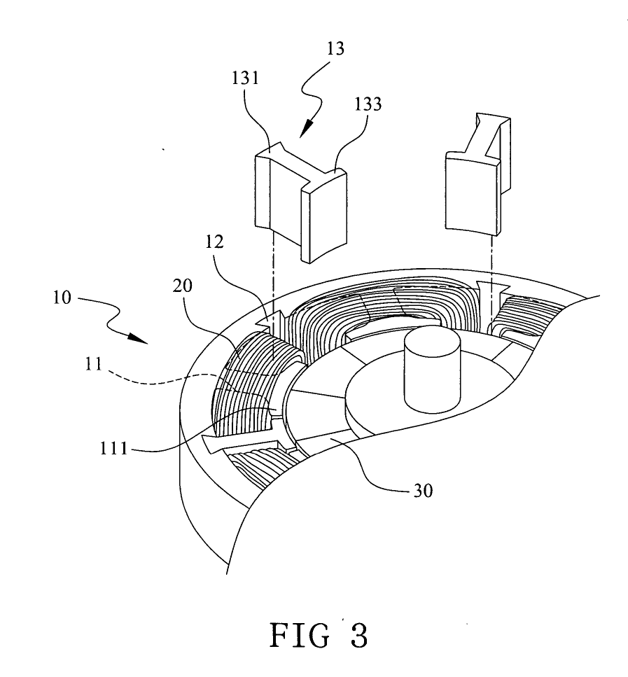

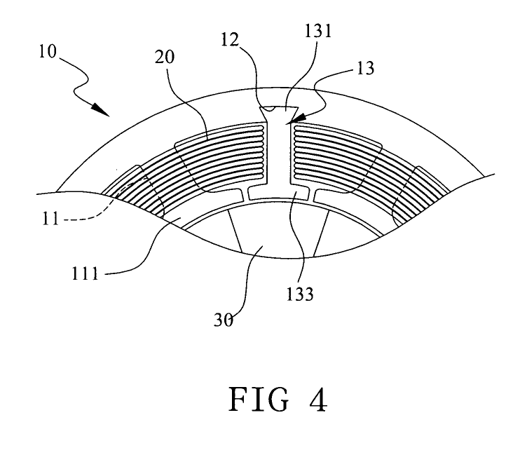

Referring to FIGS. 2 to 4 for the motor stator device of the present invention, the motor stator device comprises the following elements:

A stator 10 includes a plurality of serrate portions 11, and each serrate portion 11 includes an extending portion 111 at an end of the serrate portion, and the stator 10 further includes a positioning slot between two adjacent serrate portions 11 disposed at an internal wall of the stator 10, and each positioning slot 12 comes with a tooth 13, and the tooth 13 has a combining portion 131 at one end of the tooth for combining with a positioning slot 12 at an internal wall of the stator 10 and an extending portion 133 at another end of the tooth 13, and the extending portion 133 of each tooth 13 is corresponsive with the extending portion 111 of each serrate portion 11.

A plurality of coils 20 are provided, and each coil 20 is wound around each serrate portion 11 in the stator 10.

A rotor 30 (which is a magnet) is installed in the stator 10 for producing an electromagnetic attraction to drive the rotor 30 to rotate, when the coils 20 on the stator 10 is connected electrically.

Referring to FIGS. 2 to 4 for the motor stator device comprised of the aforementioned components, the present invention is characterized in that the motor stator device includes a stator 10, a plurality of coils 20, and a rotor 30, wherein the stator 10 includes a positioning slot disposed between two adjacent serrate portions 11 and combined with a corresponding tooth 13, such that each coil 20 can be wound around each serrate portion 11 in the stator 10 first. By then, each tooth 13 is not connected with the stator 10 yet, and a combining portion 131 at an end of the tooth 13 is connected to the positioning slot 112 at an internal wall of the stator 10, after the coil 20 is wound, such that there will be no space limitation during the winding of each coil 20 for facilitating the winding of the coil 20. The volume for winding each coil 20 becomes relatively larger. After the space for winding the coil 20 is increased, coils with different thicknesses can be wound conveniently, only if the tooth 13 is not touched, and thus effectively improving the area occupying percentage and the performance of the conducting wire and reducing the detention torque. The stator 10 is integrally formed, so that the overall rigidity of the motor is very good. A positioning slot 12 is disposed between two adjacent serrate portions 11 of the stator 10 for respectively connecting each additional tooth 13, so as to effectively reduce the gap of tooth groove between an extending portion 111 of each serrate portion 11 and an extending portion 133 of each tooth 13, effectively lower the tooth groove effect, and improve the overall performance. The invention achieves the effects of winding a coil conveniently, increasing the area occupying percentage of the conducting wire and the performance, and lower the detention torque, and thus enhancing the practicability and convenience for the motor.

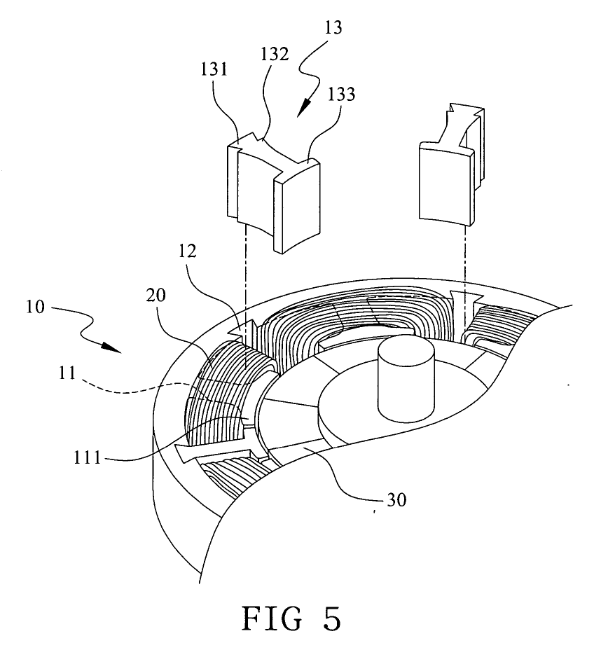

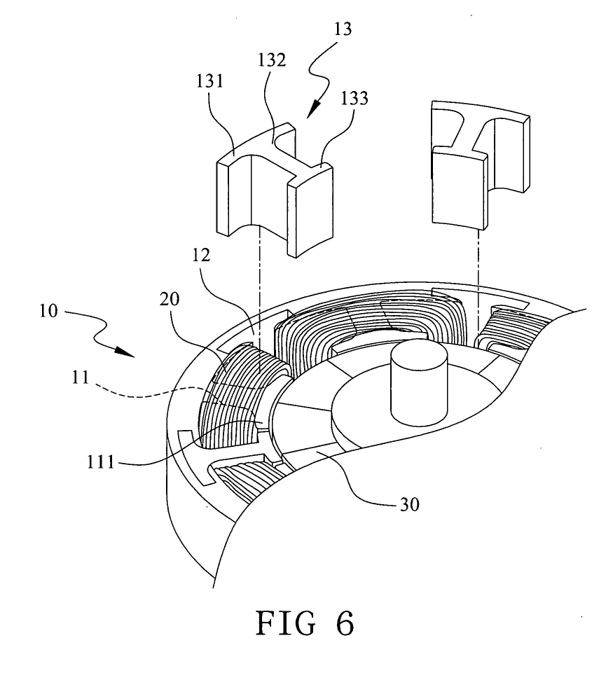

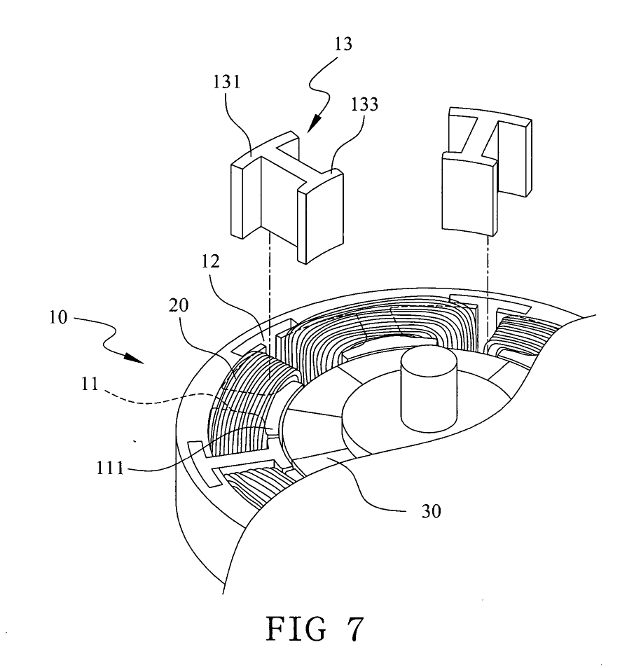

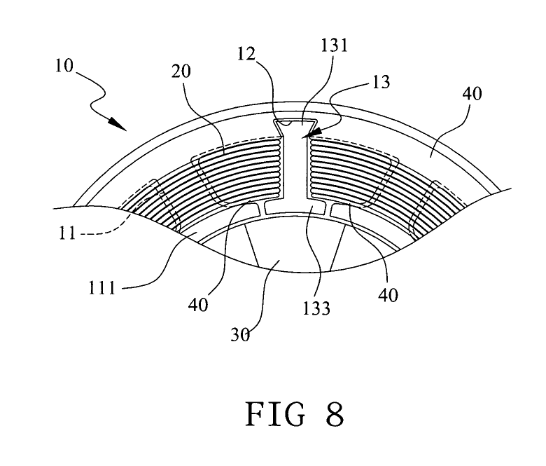

Referring to FIGS. 2 to 4, the combining portion 131 of the tooth 13 is designed as a dovetailed member and the positioning slot 12 at an internal wall of the stator 10 is designed as a dovetailed slot for securely combining the tooth 13 and the stator 10. Referring to FIG. 5, the dovetailed member of the tooth 13 includes an extended side wing 132 substantially in a shape of a protruding rib and disposed at an adjacent side of the dovetailed member for pressing and positioning the tooth 13 and an internal wall of the stator 10 with each other. Referring to FIG. 6, the combining portion 131 of the tooth 13 includes an arc extended side wing 132 disposed at an adjacent side of the combining portion 131 for securely connecting the tooth 13 and an internal wall of the stator 10 with each other. Referring to FIG. 7, the tooth 13 also could be H-shaped and securely combined with the positioning slot 12 at an internal wall of the stator 10. Referring to FIG. 8, the stator 10 can install a plastic cover 40, so that the extending portion 111 of the serrate portion 11 forms a corresponding extending portion by the plastic cover 40 for winding the coil 20 and giving a secured support.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motor stator device, comprising:
a stator, having a plurality of serrate portions therein, and a positioning slot disposed between said two adjacent serrate portions of an internal wall of said stator, and each positioning slot having a tooth;
a plurality of coils, each being wound around each serrate portion in said stator; and
a rotor, installed in said stator for producing an electromagnetic attraction to drive said rotor to rotate, when said coil on said stator is connected electrically; so as to enhance the overall rigidity of a motor and enhance the area occupying percentage of a conducting wire and the performance.

2. The motor stator device of claim 1, wherein said tooth comprises a combining portion disposed at an end of said tooth for combining a positioning slot disposed at an internal wall of said stator, and an extending portion disposed on another end of said tooth.

3. The motor stator device of claim 2, wherein said combining portion of said tooth is a dovetailed member, and said positioning slot in an internal wall of said stator is a dovetailed slot for securing the connection of said tooth and said stator.

4. The motor stator device of claim 3, wherein said dovetailed member of said tooth includes an extended side wing substantially in the shape of a protruding rib and disposed at an adjacent side of said tooth for securely pressing said extended side with an internal side of said stator.

5. The motor stator device of claim 2, wherein said combining portion of said tooth includes an extended side wing substantially in an arc shape for securely connecting said extended side and an internal side of said stator with each other.

6. The motor stator device of claim 2, wherein said tooth is H-shaped.

7. The motor stator device of claim 1, wherein said stator further includes a plastic cover, such that an extending portion of said serrate portion is extended by said plastic cover to become an extending portion for winding said coil and providing a secured support.
